(19) United States
(12) Patent Application Publication
(10) Pub. No.: US 2026/0070669 A1
(43) Pub. Date: Mar. 12, 2026

(54) PROPULSION SYSTEM FOR AN AIRCRAFT COMPRISING AN ENGINE, A PYLON AND A STRUCTURAL ENGINE DUCT

(71) Applicant: Airbus Operations GmbH, TOULOUSE (FR)

(72) Inventors: Pascal GOUGEON, TOULOUSE (FR); Alexandre BELLANGER, TOULOUSE (FR); Lionel SILLIERES, TOULOUSE (FR); Simon VANDERBAUWEDE, TOULOUSE (FR); Nicolas CHARTON, TOULOUSE (FR); Julien VINOT, TOULOUSE (FR); Xavier CARCENAC, TOULOUSE (FR); David AYRAL, TOULOUSE (FR)

(21) Appl. No.: 19/320,713

(22) Filed: Sep. 5, 2025

Related U.S. Application Data
(60) Provisional application No. 63/691,580, filed on Sep. 6, 2024.

(51) Int. Cl. B64D 27/40

(52) U.S. Cl. CPC B64D 27/402

(57) ABSTRACT

A propulsion system includes an engine, a pylon box, and a structural attachment. The engine includes an engine casing and an engine core. The pylon box has a front part and a rear part. The rear part is configured to attach the engine to an aircraft structure. The structural attachment has a front end configured to attach to the engine casing and a rear end configured to attach to the pylon which allows load transfer to the aircraft structure through the pylon box.

### RELATED APPLICATIONS

This application claims priority to U.S. Provisional Application No. 63/691,580 filed on Sep. 6, 2024, the entirety of which is incorporated herein by reference.

### FIELD OF THE INVENTION

The present invention relates to the general field of attachment of an engine under the wing of an aircraft. It concerns in particular a propulsion system comprising an engine, in particular a double-flow engine, a pylon, and a structural attachment allowing load transfer to the aircraft structure through the pylon. It also applies to an aircraft equipped with such a propulsion system.

### BACKGROUND OF THE INVENTION

With reference to FIG. 1, an aircraft 50 comprises a plurality of propulsion system 100 having an engine each surrounded by a nacelle 102 at least partly that are positioned beneath the wing 52 of the aircraft 50. These attachment elements often consist of a front engine attachment and a rear engine attachment.

As shown in FIG. 2, the propulsion system 100 comprises an engine, a nacelle 102 positioned at least partly around the engine and also a pylon 104 that provides the connection between the engine and the rest of the aircraft 50, in particular the wing 52. The pylon 104 comprises a primary structure 106 in the form of a box that is connected to the engine by a front engine attachment 166, a rear engine attachment 157 and a pair of rods 156 that react the forces.

It is desirable to find an alternative arrangement that allows, among other things, a better transfer of loads towards the rear of the pylon.

The aim of the present invention is to propose an alternative to such propulsion system.

### SUMMARY OF THE INVENTION

A new propulsion system has been invented and is described in various embodiments herein.

In at least one aspect, the present invention, broadly, may be characterized as providing a propulsion system having: an engine with an engine casing and an engine core; a pylon box with a front part and a rear part; the rear part configured to attach the engine to an aircraft structure; and a structural attachment, having a front end configured to attach to the engine casing and a rear end configured to attach to the pylon box, allowing load transfer to the aircraft structure through the pylon box.

The structural attachment may include a duct configured to at least partially surround the engine core, the duct having a fixed structure, the fixed structure having at least an upper beam and a ring, the upper beam fixed to the engine casing and the ring fixed to the upper beam and to the pylon box. The ring may include an upper half ring and a lower half ring that are configured to attach to one another to form the ring. The upper beam may include a first spar, a second spar, and a third spar, and each spar is configured to attach to a first stringer, a second stringer, and a third stringer of the engine casing. Each spar may have an upper face, a lower face, and two lateral faces. The first spar, the second spar, and the third spar may be attached to an upper skin and to a lower skin to form a box. The duct may include a mobile structure that has at least one panel. The upper beam may include at least one hinge, the at least one panel attached to the at least one hinge so that the at least one panel is configured to rotate around a longitudinal line orientated along an X axis of the engine.

The propulsion system may also include centering rods configured to alleviate inertial loads of the engine core, the centering rods positioned to form a triangle, a first end of each of the centering rod attached to a ring of the structural attachment, and a second end of each of the centering rods attached to the engine core.

The structural attachment may include a fixed structure having a lower beam attached to the engine casing and a ring.

In at least one aspect, the present invention may be generally characterized as providing a propulsion system having: an engine with an engine casing and an engine core; a pylon box configured to secure the engine to an aircraft structure; and a duct at least partly surrounding the engine core, the duct having a fixed structure, the fixed structure comprising an upper beam and a ring, the upper beam fixed to the engine casing, and the ring fixed to the upper beam and to the pylon box.

The ring may include an upper half ring and a lower half ring that are configured to attach to one another to form the ring.

The duct may include a mobile structure that has at least one panel. The upper beam may include at least one hinge, the at least one panel attached to the at least one hinge so that the at least one panel is configured to rotate around a longitudinal line orientated along an X axis of the engine.

The upper beam may include a first spar, a second spar, and a third spar, and each spar may be configured to attach to a first stringer, a second stringer, and a third stringer of the engine casing. The first spar, the second spar, and the third spar may be attached to an upper skin and to a lower skin to form a box. The upper skin and the lower skin may each be curved to follow a profile of the engine core and a profile of the duct.

The propulsion system may further include centering rods configured to alleviate inertial loads of the engine core, the centering rods positioned to form a triangle, a first end of each of the centering rods attached to the ring, and a second end of each of the centering rods attached to the engine core.

In at least one aspect, the present invention may be characterized generally as providing a propulsion system having: an engine with an engine casing and an engine core; a pylon box configured to secure the engine to an aircraft structure; a duct surrounding the engine core and including a fixed structure, the fixed structure having an upper beam and a rear ring, the upper beam fixed to the engine casing and the rear ring fixed, at 12 o'clock, to the upper beam and to the pylon box; and, a first panel and a second panel mounted on the upper beam, the first and second panels forming a closed barrel, the closed barrel, at least partly, surrounding the engine core and configured to transfer loads from the engine to the pylon box. Finally, in at least one aspect, the present invention may be characterized as providing, an aircraft with the propulsion system according to any of the aspects or embodiments described herein.

### BRIEF DESCRIPTION OF THE DRAWINGS

The aforementioned features of the invention, along with others, will become more clearly apparent on reading the following description of one exemplary embodiment, said description being given with reference to the appended drawings, in which:

FIG. 1 is a side view of an aircraft provided with a propulsion system;

FIG. 2 is a partial view in perspective of a propulsion system according to a prior art;

FIG. 3 is a schematic view of the two global parts of an engine;

FIG. 4 is a perspective view of a propulsion system according to the present invention with a closed mobile structure;

FIG. 5 is a perspective view where the mobile structure has been removed;

FIG. 6 is a side view of the propulsion system according to the present invention with a closed mobile structure;

FIG. 7 is a section drawing according to plane H3 of FIG. 6;

FIG. 8 is a section drawing according to planes H1/H2 of FIG. 6;

FIG. 9 is a schematic view of the loads transfer in the propulsion system of the present invention;

FIG. 10 is a perspective view of a propulsion system according to the present invention with an opened mobile structure with no lower beam within the fixed structure;

FIG. 11 is a drawing section according to plane A-A of FIG. 6; and,

FIG. 12 is a partial view in perspective showing in transparency stringers of the engine casing.

### DETAILED DESCRIPTION OF THE INVENTION

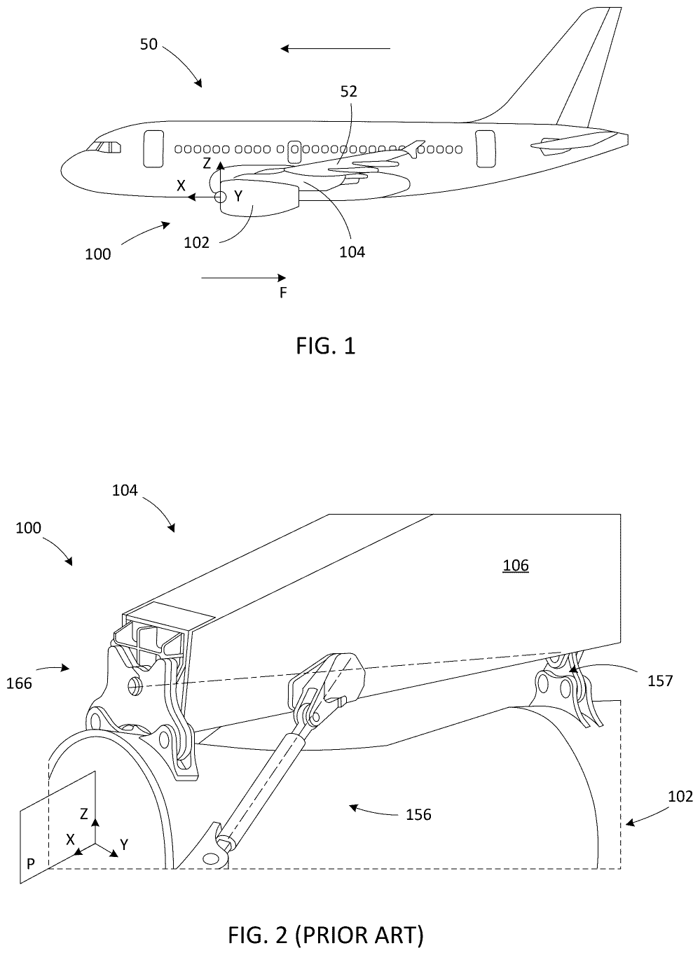

For the remainder of the description, a longitudinal direction X is parallel to the axis of the engine. A transverse plane is a plane perpendicular to the longitudinal direction X. A transverse and horizontal direction Y is a direction perpendicular to the longitudinal direction X and horizontal. A transverse and vertical direction Z is a direction perpendicular to the longitudinal direction X and vertical. A vertical median plane is a plane parallel to the direction X and containing the engine axis. The terms front and rear refer to the direction of flow F (arrow F on FIG. 1) of the stream of air in the engine, this stream flowing from the front towards.

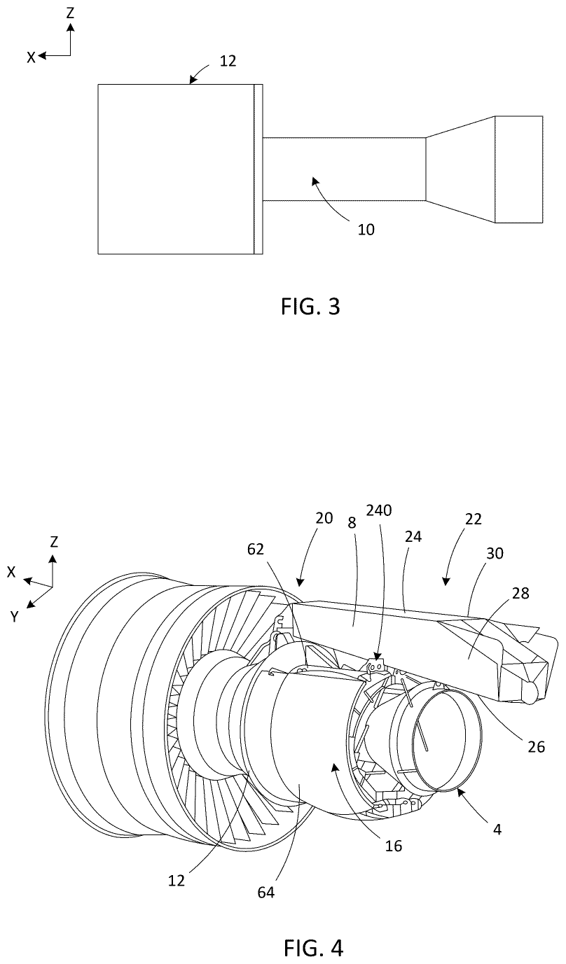

Turning to FIGS. 3 and 4, the aircraft 50 comprises a plurality of engines 4 that are positioned beneath the wing 52 of the aircraft 50 (same figure as FIG. 1 but with the propulsion system described hereunder in reference to FIGS. 3 to 11).

A propulsion system 2 comprises an engine 4 and a pylon box 8 that provides the connection between the engine 4 and the wing 52 of the aircraft 50. As illustrated in FIG. 3, the engine comprises an engine core 10 and an engine casing 12 at the front of the engine core. The engine casing 12 is the part that surrounds or maintains the fan(s) of the engine depending on the type of engine (turbojet (for example double flow/bypass turbojet as turbofan), unducted fan engine (as open rotor, propfan . . . ) . . . ). The engine core 10 is the rest of the engine not at the level of the propulsive fan(s). An attachment system or structural duct 16 described hereunder at least partly surrounds the engine core 10.

The pylon box 8 comprises a primary structure comprising two parts: a front part 20 mainly linked to the engine through an attachment set which will not be described in detail as it is not part of the present invention and a rear part 22 mainly joined to the aircraft and in particular to the wing through a wing attachment system. The pylon box 8 is in the form of a box comprising an upper spar 24, a lower spar 26, and two lateral panels 28, 30 to form the pylon box 8.

The duct 16 of the present invention is a structural duct allowing load transfer from the engine to the aircraft structure and from the wing through the pylon. The duct 16 is made of a fixed structure 62 and a mobile structure 64.

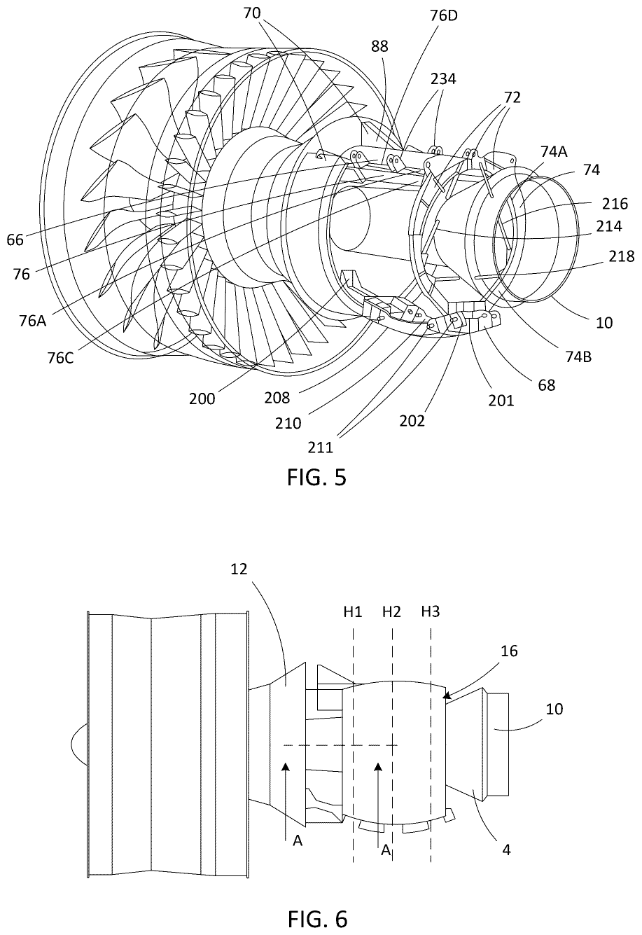

The fixed structure 62 of the duct 16 comprises an upper beam 66 and optionally a lower beam 68 (FIG. 5). The upper beam 66 of the duct 16 is attached to the engine casing 12 on its front side and on its rear side to the rear part 22 of the pylon. The front end 70 of the upper beam 66 is linked to the engine casing 12 and its rear end 72 to an annular frame 74 called a ring 74 which is linked to the pylon box 8.

In the illustrated embodiment, the ring 74 is made of two dismountable upper (74A) and lower (74B) half rings: the upper half ring 74A and the lower half ring 74B are attached to one another to form said one piece ring 74 through dismountable fixing means (not shown as of the known type) allowing loads transfer. This arrangement allows both the lower half ring and the lower beam (when there is a lower beam) to separate from the rest of the propulsion system.

In the present embodiment, and as better seen on FIG. 8, the upper beam 66 is made of three longitudinal spars 76, 78, 80: one central spar 78 at 12 o'clock in the vertical median plane YZ of symmetry and two lateral spars 76, 80 on both sides of the central spar 78. Each spar in the present embodiment has a parallelepiped section with four faces: for example, the spar 76 has an upper face 76A, a lower face 76B and two lateral faces 76C and D (FIGS. 5 and 8) (same for each spar). In the present embodiment also, as shown on FIG. 5, the front end of each spar 76, 78, 80 is attached to a respective stringer 82, 84 (two of them are shown in transparency on FIG. 12) of the engine casing 12.

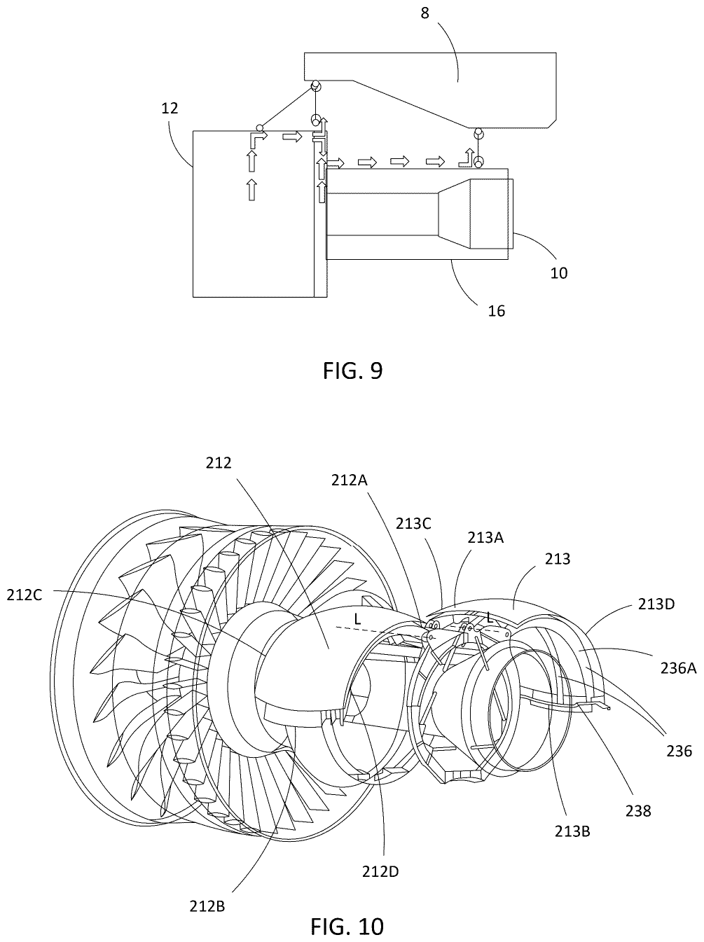

This provides a strong attachment allowing the transfer of charges illustrated by the arrows on FIG. 9 from the engine casing 12 to the pylon 8 through the duct 16.

In order to increase the inertia of the upper beam 66, the spars 76, 78, 80 are linked to create a box 88 (FIGS. 5 and 8). As can be seen on FIG. 8, the upper face 76A, 80A of the lateral spars 76, 80 are linked to the upper face 78A of the central spar 78 through a respective upper skin 90, 92. The lower face 76B, 80B of the lateral spars are linked to the lower face 78B of the central spar 78 through a respective lower skin 94, 96.

The skins 90, 92, 94, 96 are curved to follow the profile of the engine core 10 and the global profile of the duct 16. The box is completely closed with at one of the longitudinal ends at the engine casing 12 and the other longitudinal end at the ring 74. However, some other embodiments are possible: in the illustrated one, the skins 90, 92, 94, 96 are not in the extension of the panels: it follows a flattened shape compared to the global profile of the duct in order to let enough space between the upper beam and the pylon.

Optionally, the fixed structure 62 of the duct 16 comprises a lower beam 68. As shown on FIGS. 5 and 8, said lower beam 68 is positioned at 6 ok in the vertical median plane YZ. The lower beam 68 comprises an elongated longitudinal surface 201 with a double curvature to follow the profile of the duct 16 aimed at following the contours of the engine core: its front end 200 is attached to the engine casing 12 and more precisely to a stringer of the engine casing. Its rear end 202 is attached to the lowest part of the ring 74 or can even be part of the lowest part of the ring: those strong front and rear attachment allows loads to be transferred from the engine casing to the pylon through the lower beam and ring. The lower beam 68 comprises lateral edges 208, 210 in a radial direction allowing to support latch 211 to lock lateral rotative panels 212, 213 (FIG. 8) on the lower beam 68 described later on. As indicated, the lower beam is optional as the lateral panels 212, 213 could be lock to one another (FIG. 10). The lock through latch associated with pins and bumpers will not be described as already known. Any other types of latches appropriate to such configuration could be used.

Optionally, as shown in FIGS. 4, 5, 7 and 10, three centering rods 214, 216, 218 can be provided to alleviate the inertial loads of the cantilevered core engine 10. Those rods 214, 216, 218 are positioned in a transverse plane YZ to form a triangle around the core engine 10. Each rod is attached to the engine core approximately in the middle part of said rods: those rods allow to limit the displacements of the engine. Each extremity 220, 222 of the lower rod 218 oriented in a transverse Y direction is attached to the lower part of the ring 74. One extremity 224, 226 of the two other lateral rods 214, 216 (of the two other sides of the triangle) is attached to the lower part of the ring near the lower rod 218 and the other extremities 228, 230 to the upper part of the ring near one another.

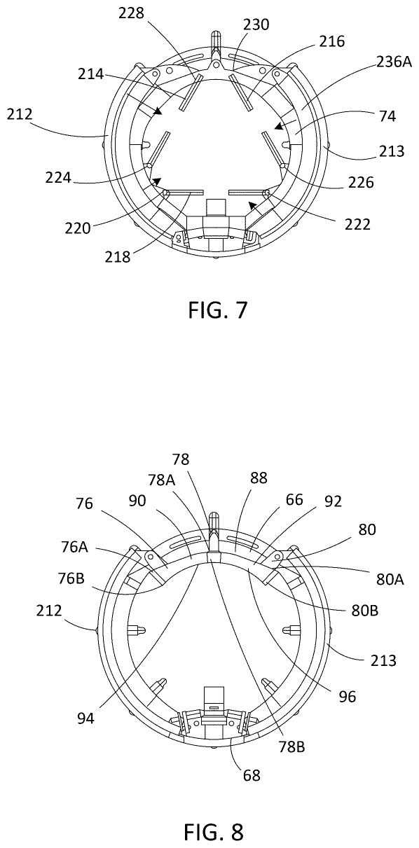

The upper beam 66 is provided with hinges 234 (FIG. 5). The mobile structure of the duct 16 comprises panels 212, 213 (FIGS. 7, 8, 10) which are articulated to the hinges 234. The panels 212, 213 comprises four sides: as illustrated on FIG. 10, an upper side 212A, 213A, a lower side 212B, 213B, a front side 212C, 213C and a rear side 212D, 213D. The upper side 212A, 213A is linked to the upper beam 66 so that the panel can rotate around a line L oriented in a longitudinal X direction. The attachment to the hinges is such that loads are transferred from the upper beam to the panels. As shown in FIGS. 4 and 10, the panels can move between a closed position shown on FIG. 4 and an opened deployed position shown on FIG. 10 allowing an operator to have easy access to the core engine 10. The panels are provided with ribs 236 in the transverse Y direction and ribs 238 in the X longitudinal direction. The transverse ribs 236 are the one articulated on hinges 234 so that the panel rotates around a line L in a X direction. Regarding the lower side 212B, 213B of the panel, as already mentioned, two alternatives are possible. In one case, the lower side is locked to a lower beam through classical latch. In another case, the lower side of the two panels are locked to one another.

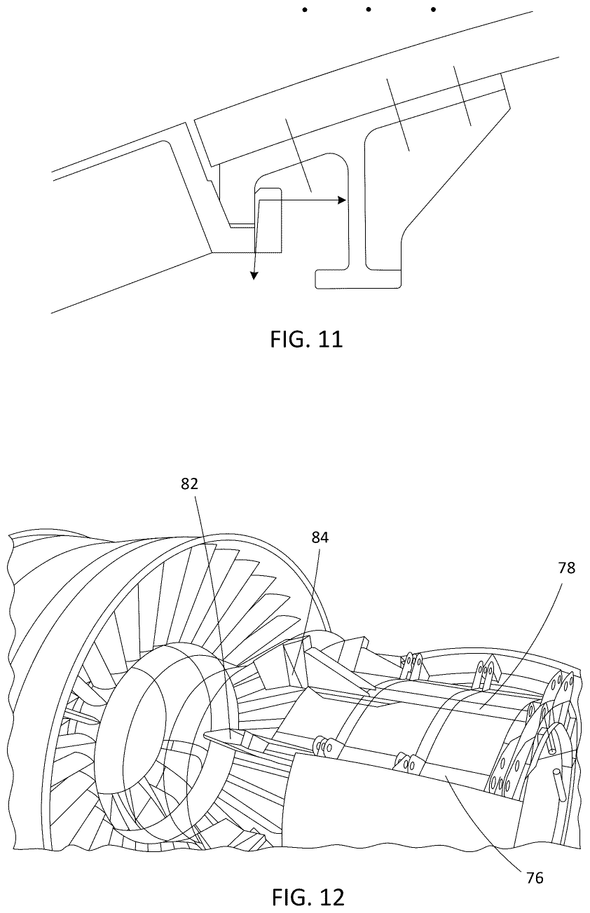

The front side 212C, 213C of the panels are linked to the engine casing through a classical J ring/V groove locking which is illustrated on FIG. 11.

Regarding the rear side 212D, 231D, as can be seen from the FIGS. 7 and 10, one of the transverse ribs 236A is facing the ring 74 so that when in closed position the rib 236A is pushing/pressing the ring 74 (as shown by arrows on FIG. 7) in order to transfer the loads from the panel to the ring. Any other mechanical known links can be used to connect the panels to the fixed structure and engine casing. For example, for the link between the panel and the ring, a J ring/V groove as on FIG. 11 could have been applied or even a latch as for the link between the panel and lower beam.

Once the panels are in a closed position, the duct 16 shall be a complete 360° barrel surrounding the core engine and transferring the loads to the aircraft structure.

The fixed and mobile structures can be provided with an acoustic panel and made of a fire resistant material.

The structural duct 16 of the present invention combines multiple functions: aerodynamic surface, acoustic treatment, fire barrier, load transfer from engine to pylon, easy and rapid access to engine core for maintenance. There is no need for ground support equipment and the risk of damage to the duct, engine or aircraft is decreased.

As illustrated in FIG. 4, classical pylon attachment system 240 are provided to link the ring to the pylon.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A propulsion system comprising:
an engine comprising an engine casing and an engine core;
a pylon box with a front part and a rear part; the rear part configured to attach the engine to an aircraft structure; and
a structural attachment, having a front end configured to attach to the engine casing and a rear end configured to attach to the pylon box, allowing load transfer to the aircraft structure through the pylon box.

2. The propulsion system according to claim 1, wherein the structural attachment further comprises a duct configured to at least partially surround the engine core, the duct having a fixed structure, the fixed structure comprising at least an upper beam and a ring, the upper beam fixed to the engine casing and the ring fixed to the upper beam and to the pylon box.

3. The propulsion system according to claim 2, wherein the ring further comprises an upper half ring and a lower half ring that are configured to attach to one another to form the ring.

4. The propulsion system according to claim 2, wherein the upper beam comprises a first spar, a second spar, and a third spar,
wherein each spar is configured to attach to a first stringer, a second stringer, and a third stringer of the engine casing.

5. The propulsion system according to claim 4, wherein each spar has an upper face, a lower face, and two lateral faces.

6. The propulsion system according to claim 4, wherein the first spar, the second spar, and the third spar are attached to an upper skin and to a lower skin to form a box.

7. The propulsion system according to claim 2, wherein the duct further comprises a mobile structure that has at least one panel.

8. The propulsion system according to claim 7, wherein the upper beam further comprises at least one hinge, the at least one panel attached to the at least one hinge so that the at least one panel is configured to rotate around a longitudinal line orientated along an X axis of the engine.

9. The propulsion system according to claim 1, further comprising:
centering rods configured to alleviate inertial loads of the engine core, the centering rods positioned to form a triangle, a first end of each of the centering rod attached to a ring of the structural attachment, and a second end of each of the centering rods attached to the engine core.

10. The propulsion system according to claim 1, wherein the structural attachment comprises a fixed structure comprising a lower beam attached to the engine casing and a ring.

11. An aircraft comprising:
the propulsion system according to claim 1.

12. A propulsion system comprising:
an engine comprising an engine casing and an engine core;
a pylon box configured to secure the engine to an aircraft structure; and
a duct at least partly surrounding the engine core, the duct having a fixed structure, the fixed structure comprising an upper beam and a ring, the upper beam fixed to the engine casing, and the ring fixed to the upper beam and to the pylon box.

13. The propulsion system according to claim 12, wherein the ring further comprises an upper half ring and a lower half ring that are configured to attach to one another to form the ring.

14. The propulsion system according to claim 12, wherein the duct further comprises a mobile structure that has at least one panel.

15. The propulsion system according to claim 14, wherein the upper beam further comprises at least one hinge, the at least one panel attached to the at least one hinge so that the at least one panel is configured to rotate around a longitudinal line orientated along an X axis of the engine.

16. The propulsion system according to claim 12, wherein the upper beam comprises a first spar, a second spar, and a third spar, and
wherein each spar is configured to attach to a first stringer, a second stringer, and a third stringer of the engine casing.

17. The propulsion system according to claim 16, wherein the first spar, the second spar, and the third spar are attached to an upper skin and to a lower skin to form a box.

18. The propulsion system according to claim 17, wherein the upper skin and the lower skin are each curved to follow a profile of the engine core and a profile of the duct.

19. The propulsion system according to claim 12, further comprising:
centering rods configured to alleviate inertial loads of the engine core, the centering rods positioned to form a triangle, a first end of each of the centering rods attached to the ring, and a second end of each of the centering rods attached to the engine core.

20. A propulsion system comprising:
an engine comprising an engine casing and an engine core,
a pylon box configured to secure the engine to an aircraft structure,
a duct surrounding the engine core and comprising a fixed structure, the fixed structure comprising an upper beam and a rear ring, the upper beam fixed to the engine casing and the rear ring fixed, at 12 o'clock, to the upper beam and to the pylon box, and,
a first panel and a second panel mounted on the upper beam, the first and second panels forming a closed barrel, the closed barrel, at least partly, surrounding the engine core and configured to transfer loads from the engine to the pylon box.
